(19) United States
(12) Patent Application Publication
(10) Pub. No.: US 2006/0185006 A1
(43) Pub. Date: Aug. 17, 2006

(54) Flash card capable of enabling or disabling CPRM function

(75) Inventors: Gordon Yu, Taipei City (TW); Hung-Tse Ho, Taipei City (TW); Hsueh-Yao Wang, Lujhou City (TW); Ming-Che Chang, Tainan City (TW)

Correspondence Address: BACON & THOMAS, PLLC, 625 SLATERS LANE, FOURTH FLOOR, ALEXANDRIA, VA, 22314, US

(73) Assignee: C-One Technology Corporation, Hsin-Chu City (TW)

(21) Appl. No.: 11/218,641

(22) Filed: Sep. 6, 2005

(30) Foreign Application Priority Data
Jan. 20, 2005 (TW) 094101678

(51) Int. Cl. H04L 9/32

(52) U.S. Cl. 726/9

(57) ABSTRACT

Provided is a flash card capable of enabling or disabling CPRM. The flash card comprises a card body; a plurality of contacts formed on a front end of the card body; a flash memory chip provided in the card body; and a controller electrically connected to the contacts and the flash memory chip respectively. The controller comprises at least one register having a preset value. Data in the flash memory chip is adapted to be accessed via the controller either in a CPRM mode when a CPRM function of the flash memory chip is enabled by setting the preset value as a CPRM function enabled or in a normal mode when the CPRM function of the flash memory chip is disabled by setting the preset value as a CPRM function disabled.

### BACKGROUND OF THE INVENTION

1. Field of the Invention

The present invention relates to technical field of flash cards and, more particularly, to a flash card capable of enabling or disabling CPRM (content protection for recordable media) function.

2. Description of Related Art

Typically, flash card is advantageous for being easy in accessing data stored therein, for example by operating a card reader connected thereto. However, confidential data stored in a flash card may be read by an unauthorized person once the flash card is stolen. In view of this, a specification known as CPRM (content protection for recordable media) with respect to data stored in a flash card has been defined. CPRM enables a person to protect data stored in a flash card. As such, there is no need to worry confidential data stored in a flash card being read by an unauthorized person once the flash card is stolen. However, the protection may block the operation of sharing data with other people when such need arises. Thus, a need for improvement exists in order to contribute significantly to the advancement of the art.

### SUMMARY OF THE INVENTION

An object of the present invention is to provide a flash card capable of enabling or disabling CPRM function, which comprises: a card body; a plurality of contacts formed on a front end of the card body; a flash memory chip provided in the card body; and a controller electrically connected to the contacts and the flash memory chip respectively, the controller comprising at least one register having a preset value; wherein data in the flash memory chip is adapted to be accessed via the controller either in a CPRM mode when a CPRM function of the flash memory chip is enabled by setting the preset value as a CPRM function enabled or in a normal mode when the CPRM function of the flash memory chip is disabled by setting the preset value as a CPRM function disabled.

Another object of the present invention is to provide a flash card capable of enabling or disabling CPRM function, which comprises: a card body; a plurality of contacts formed on a front end of the card body; a flash memory chip provided in the card body; a switch contact formed on the card body, the switch contact being adapted to receive a switch signal; and a controller electrically connected to the switch contact and the flash memory chip respectively, the controller receives the switch signal via the switch contact; wherein data in the flash memory chip is adapted to be accessed via the controller either in a CPRM mode when a CPRM function of the flash memory chip is enabled in response to a high level of the switch signal, or in a normal mode when the CPRM function of the flash memory chip is disabled in response to a low level of the switch signal.

Therefore, the flash card capable of enabling or disabling CPRM function is able to protect data in a flash memory chip thereof without sacrificing an easy data access. Further, in the flash card of the present invention, the flash memory chip comprises a general region and a CPRM region and data in the general region is adapted to be accessed in the normal mode when the CPRM function of the flash memory chip is disabled; and the controller comprises at least one register having a preset value for enabling or disabling the CPRM function of the flash memory chip.

Other objects, advantages, and novel features of the invention will become more apparent from the detailed description when taken in conjunction with the accompanying drawings.

### BRIEF DESCRIPTION OF THE DRAWINGS

FIG. 1 is a schematic block diagram of a first preferred embodiment of flash card according to the invention;

FIG. 2 is a schematic block diagram of a second preferred embodiment of flash card according to the invention;

FIG. 3 is a schematic block diagram of a third preferred embodiment of flash card according to the invention;

FIG. 4 is a schematic block diagram of a fourth preferred embodiment of flash card according to the invention; and

FIG. 5 is a schematic block diagram of a fifth preferred embodiment of flash card according to the invention.

### DETAILED DESCRIPTION OF THE PREFERRED EMBODIMENT

Enabling or disabling CPRM in a flash card may be carried out by software or hardware. In the following detailed description, five preferred embodiments including both software and hardware based methods for CPRM are described.

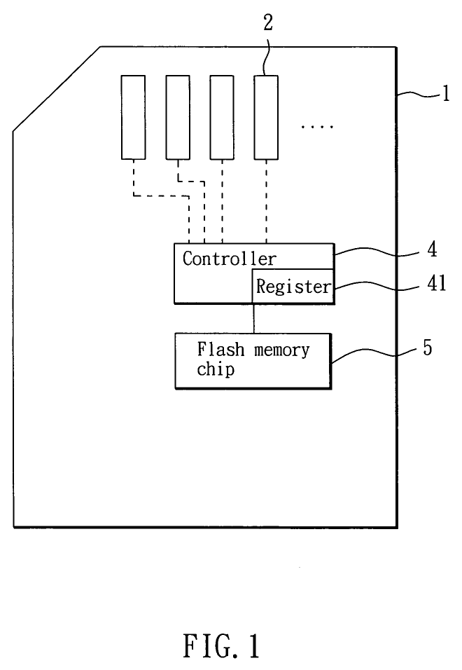

With reference to FIG. 1, there is shown a flash card in accordance with a first preferred embodiment of the invention. The flash card comprises a card body 1, a plurality of contacts 2, a flash memory chip 5, and a controller 4. The contacts 2 are provided on a front end of the card body 1. The flash memory chip 5 is provided in the card body 1. The controller 4 is electrically connected to the contacts 2 and the flash memory chip 5 respectively. The controller 4 comprises at least one register 41 having a value to be set for enabling or disabling a CPRM function of the flash memory chip 5. Data in the flash memory chip 5 can be accessed via the controller 4 in a CPRM mode when a CPRM function of the flash memory chip 5 is enabled by setting the value of the register 41 as CPRM function enabled. Alternatively, data in the flash memory chip 5 can be accessed via the controller 4 in a normal mode when the CPRM function of the flash memory chip 5 is disabled by setting the value of the register 41 as CPRM function disabled.

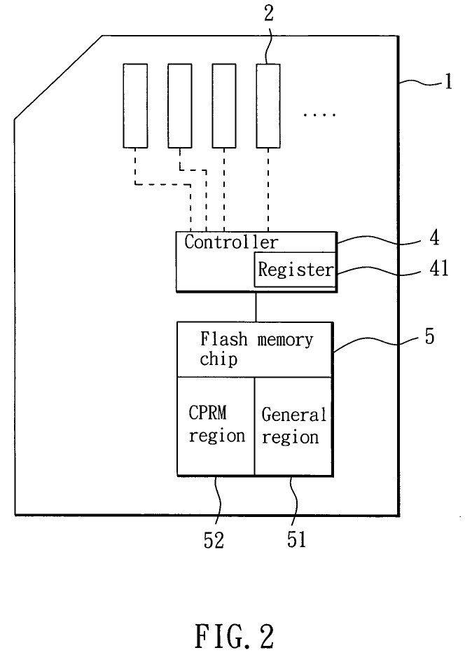

With reference to FIG. 2, there is shown a flash card in accordance with a second preferred embodiment of the invention. The second preferred embodiment substantially has same structure as the first preferred embodiment, except that, in the second preferred embodiment, the flash memory chip 5 comprises a general region 51 and a CPRM region 52. Thus, data in the CPRM region 52 of the flash memory chip 5 can be accessed via the controller 4 in the CPRM mode when the CPRM function of the flash memory chip 5 is enabled by setting the value of the register 41 as CPRM function enabled. Alternatively, data in the general region 51 of the flash memory chip 5 can be accessed via the controller 4 in the normal mode when the CPRM function of the flash memory chip 5 is disabled by setting the value of the register 41 as CPRM function disabled.

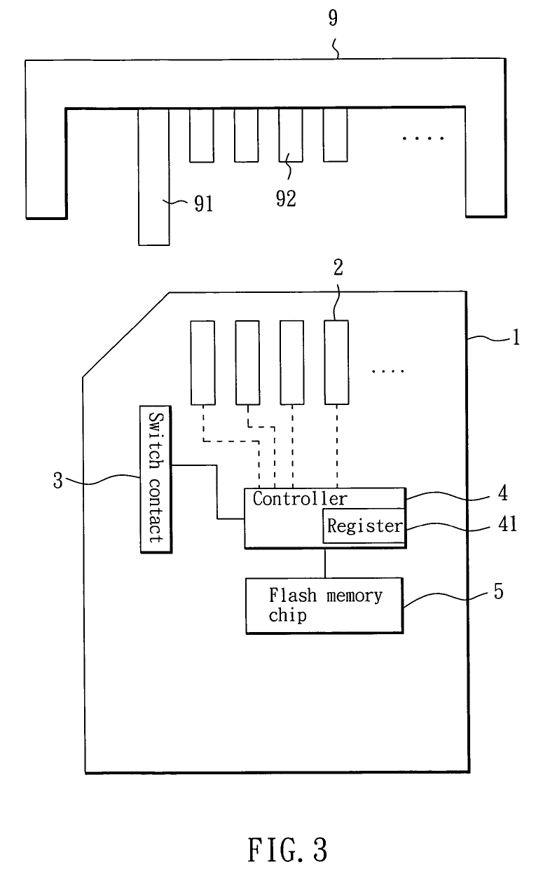

With reference to FIG. 3, there is shown a flash card in accordance with a third preferred embodiment of the invention. The third preferred embodiment substantially has same structure as the first preferred embodiment, except that, in the third preferred embodiments, a switch contact 3 is provided on the card body 1. The controller 4 is electrically connected to the switch contact 3 for receiving a switch signal therefrom. After receiving the switch signal and storing same in the register 41, the controller 4 determines whether data in the CPRM region can be accessed or not based on content of the switch signal stored in the register 41. The flash card is adapted to be inserted into a host socket 9 in which a plurality of pins 92 of the host socket 9 are adapted to come into touch with the contacts 2, and a mode control pin 91 thereof is adapted to come into touch the switch contact 3. As a result, when the flash card is inserted in the host socket 9, the host socket 9 is adapted to set a value (e.g., high level or low level) of the switch signal in the switch contact 3. Thus, data in the flash memory chip 5 can be accessed by the external device via the controller 4 and the pins 2 in the CPRM mode or the general mode based on the value of the switch signal set in the switch contact 3, since, as discussed above, the mode control pin 91 is connected to the switch contact 3 and which is in turn connected to the controller 4. Note that the function of the switch contact 3 can be disabled by setting the register 41 and be replaced by the register 41 in one configuration of the embodiment in which the function of the switch contact 3 is carried out by setting the value of the register 41 as CPRM function enabled or not.

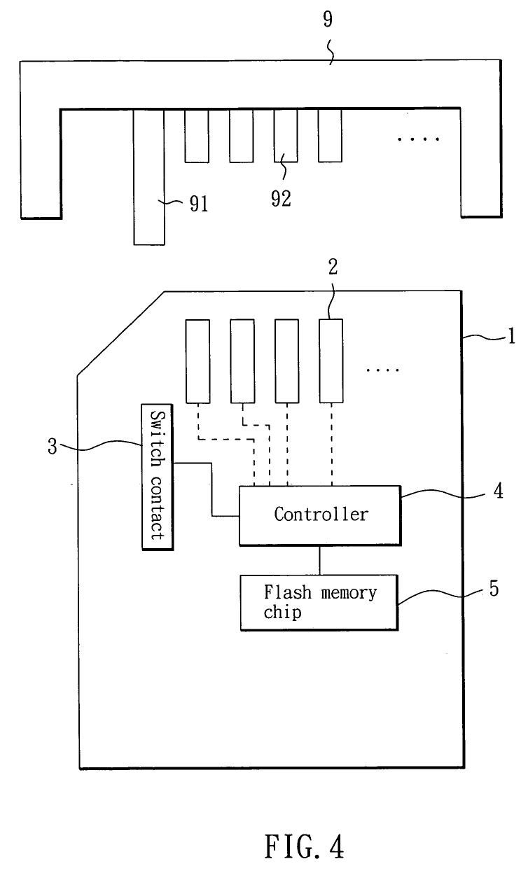

With reference to FIG. 4, there is shown a flash card in accordance with a fourth preferred embodiment of the invention. The flash card comprises a card body 1, a plurality of contacts 2, a flash memory chip 5, a switch contact 3, and a controller 4. The contacts 2 are provided on a front end of the card body 1 and are served as functions of data bus, control, clock, and power. The flash memory chip 5 is provided in the card body 1 and is electrically connected to the controller 4. Thus, data in the flash memory chip 5 can be accessed via the contacts 2 as controlled by the controller 4. Moreover, the controller 4 is electrically connected to the switch contact 3 and the flash memory chip 5 respectively. The controller 4 is thus adapted to enable an external device to read data from the flash memory chip 5 by connecting pins of the external device to the contacts 2 and by connecting a mode control pin 91 thereof to the switch contact 3 respectively, since, as discussed above, the switch contact 3 is connected to the controller 4.

With reference to FIG. 4 again, the flash card is adapted to be inserted into the host socket 9. The host socket 9 comprises a plurality of pins 92 adapted to come into touch with the contacts 2, and a mode control pin 91 adapted to come into touch with the switch contact 3. As a result, when the flash card is inserted into the host socket 9, the host socket 9 is adapted to set a value (e.g., high level or low level) of the switch signal in the switch contact 3. Also, the controller 4 is able to read the switch signal from the switch contact 3. Thus, data in the flash memory chip 5 can be accessed by the external device via the controller 4 in the CPRM mode when the CPRM function of the flash memory chip 5 is enabled by the switch signal having a high level. Alternatively, data in the flash memory chip 5 can be accessed by the external device via the controller 4 in the normal mode when the CPRM function of the flash memory chip 5 is disabled by the switch signal having a low level.

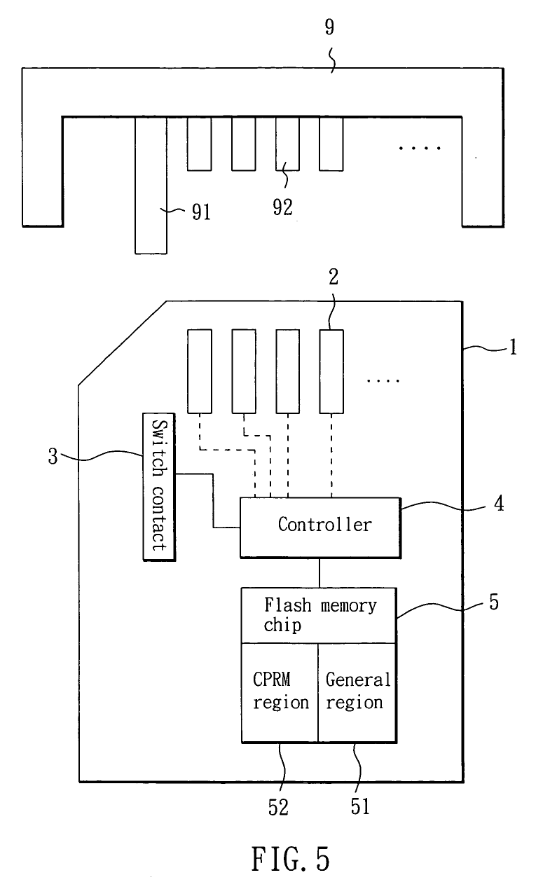

With reference to FIG. 5, there is shown a flash card in accordance with a fifth preferred embodiment of the invention. The fifth preferred embodiment substantially has same structure as the fourth preferred embodiment, except that, in the fifth preferred embodiment, the flash memory chip 5 comprises a general region 51 and a CPRM region 52. Thus, data in the CPRM region 52 of the flash memory chip 5 can be accessed via the controller 4 in the CPRM mode when the CPRM function of the flash memory chip 5 is enabled by the switch signal having a high level. Alternatively, data in the general region 51 of the flash memory chip 5 can be accessed via the controller 4 in the normal mode when the CPRM function of the flash memory chip 5 is disabled by the switch signal having a low level.

While the invention herein disclosed has been described by means of specific embodiments, numerous modifications and variations could be made thereto by those skilled in the art without departing from the scope and spirit of the invention set forth in the claims.

What is claimed is:

1. A flash card capable of enabling or disabling CPRM function, comprising:
a card body;
a plurality of contacts formed on a front end of the card body;
a flash memory chip provided in the card body; and
a controller electrically connected to the contacts and the flash memory chip respectively, the controller comprising at least one register having a preset value;
wherein data in the flash memory chip is adapted to be accessed via the controller either in a CPRM mode when a CPRM function of the flash memory chip is enabled by setting the preset value as a CPRM function enabled or in a normal mode when the CPRM function of the flash memory chip is disabled by setting the preset value as a CPRM function disabled.

2. The flash card of claim 1, wherein the flash memory chip comprises a general region and a CPRM region, and wherein data in the CPRM region is adapted to be accessed via the controller in the CPRM mode when the CPRM function of the flash memory chip is enabled by setting the preset value as the CPRM function enabled and data in the general region is adapted to be accessed via the controller in the normal mode when the CPRM function of the flash memory chip is disabled by setting the preset value as the CPRM function disabled.

3. The flash card of claim 2, further comprising a switch contact on the card body, the switch contact being electrically connected to the controller and receiving a switch signal, and after receiving the switch signal, the controller determines whether data in the CPRM region is to be accessed or not based on content of the switch signal.

4. The flash card of claim 3, wherein the flash card is adapted to be inserted into a host socket of an external device with a plurality of pins came into touch with the contacts, and a mode control pin came into touch with the switch contact, so as to enable or disable the CPRM function based on the content of the switch signal set in the switch contact.

5. A flash card capable of enabling or disabling CPRM function, comprising:
a card body;
a plurality of contacts formed on a front end of the card body;
a flash memory chip provided in the card body;
a switch contact formed on the card body, the switch contact being adapted to receive a switch signal; and
a controller electrically connected to the switch contact and the flash memory chip respectively, the controller receives the switch signal via the switch contact;
wherein data in the flash memory chip is adapted to be accessed via the controller either in a CPRM mode when a CPRM function of the flash memory chip is enabled in response to a high level of the switch signal, or in a normal mode when the CPRM function of the flash memory chip is disabled in response to a low level of the switch signal.

6. The flash card of claim 5, wherein the flash memory chip comprises a general region and a CPRM region, and wherein data in the CPRM region is adapted to be accessed via the controller in the CPRM mode when the CPRM function of the flash memory chip is enabled, and data in the general region is adapted to be accessed via the controller in the normal mode when the CPRM function of the flash memory chip is disabled.

7. The flash card of claim 5, wherein the controller has at least one register for storing the switch signal sent from the switch contact.

8. The flash card of claim 5, wherein the controller comprises at least one register having a value to be set as either the CPRM function enabled or the CPRM function disabled.

9. The flash card of claim 5, wherein the flash card is adapted to be inserted into a host socket of an external device with a plurality of pins came into touch with the contacts and a mode control pin came into touch with the switch contact, so as to enable or disable the CPRM function based on the content of the switch signal set in the switch contact.
